(19) United States
(12) Patent Application Publication
(10) Pub. No.: US 2026/0009672 A1
(43) Pub. Date: Jan. 8, 2026

(54) DISTRIBUTED ACOUSTIC SENSING SYSTEM BASED ON OPTICAL NEURAL NETWORK AND ALL-OPTICAL INTEGRATION METHOD

(71) Applicant: NANJING UNIVERSITY, Nanjing (CN)

(72) Inventors: Yixin ZHANG, Nanjing (CN); Teng MA, Nanjing (CN); Xuping ZHANG, Nanjing (CN); Xiao ZHOU, Nanjing (CN); Ningmu ZOU, Nanjing (CN); Xiangfei CHEN, Nanjing (CN); Wei JIANG, Nanjing (CN)

(73) Assignee: NANJING UNIVERSITY, Nanjing (CN)

(21) Appl. No.: 19/202,007

(22) Filed: May 8, 2025

Related U.S. Application Data
(63) Continuation of application No. PCT/CN2024/105179, filed on Jul. 12, 2024.

(30) Foreign Application Priority Data
Jul. 3, 2024 (CN) 202410885628.8

(51) Int. Cl. G01H 9/00; G01D 5/353

(52) U.S. Cl. CPC G01H 9/004; G01D 5/35319; G01D 5/35335; G01D 5/35361

(57) ABSTRACT

A distributed acoustic sensing system based on an optical neural network and an all-optical integration method are provided. The distributed acoustic sensing system based on an optical neural network includes: a distributed acoustic sensing (DAS) optical path integrated part, an external connection part, and an integrated signal processing chip. The provided combines an integrated optical delay line, a tri-port analogous detection structure and a pure optical neural network module to achieve all-optical integration of the DAS sensing system and signal processing by a pure optical method, which has the advantages of reducing photoelectric conversion, enhancing parallel processing capabilities, increasing processing speed, reducing energy consumption, improving system stability, and simplifying system architecture.

### CROSS REFERENCE TO THE RELATED APPLICATIONS

This application is a continuation application of International Application No. PCT/CN2024/105179, filed on Jul. 12, 2024, which is based upon and claims priority to Chinese Patent Application No. 202410885628.8, filed on Jul. 3, 2024, the entire contents of which are incorporated herein by reference.

### TECHNICAL FIELD

The present invention relates to the technical fields of optical fiber sensing and artificial intelligence, and in particular, to a distributed acoustic sensing system based on an optical neural network and an all-optical integration method.

### BACKGROUND

Distributed acoustic sensing (DAS) emits continuous light by using a narrow-linewidth laser, which is subjected to pulse modulation and then enters a sensing fiber for transmission, analyzes a Rayleigh backscattering light (RBS) signal generated by a sensing fiber by using a photoelectric detector, and monitors and positions weak events and changes in the optical fiber by using principles such as phase change and interference effect, so that an optical fiber network is converted into a continuous high-resolution acoustic and vibration monitoring system. DAS has the advantages of high sensitivity, high accuracy, high response speed, large coverage range, real-time monitoring and the like, is widely applied in the fields of oil gas exploration, pipeline cable monitoring, perimeter security and the like, and has extremely high application value and popularization prospect.

The traditional DAS system processes signals in a mode of photoelectric conversion, analog-to-digital conversion and digital signal processing, and a series of electrical components such as a photoelectric detector are required to be introduced to assist in completing signal demodulation. Signals are converted between light and electricity many times, each of which may introduce noise and distortion, thereby degrading signal quality. Meanwhile, the electronic components have a relatively slow operation speed when large amounts of computing are required or high precision is needed, which are slightly insufficient in applications requiring real-time accurate response. In addition, due to the introduction of photoelectric conversion, the overall design of the system becomes more complex and is susceptible to electromagnetic interference, thereby greatly increasing the maintenance cost and energy consumption and reducing the system stability.

An optical neural network (ONN) is a technique that performs neural network operations by using optical elements rather than traditional electronic elements. The optical neural network performs weighting and activating function operations by utilizing optical phenomena such as interference, diffraction, and nonlinear effects to simulate the calculations and data processing in the traditional neural network, and process and transmit signals in the form of light by optical elements. Therefore, compared with a neural network operation performed by traditional electronic elements, the optical neural network has the advantages of high speed, low latency, low energy consumption, and parallel processing, and has great application prospects in the fields of artificial intelligence, image and signal processing, quantum computing, and the like.

Therefore, it is an issue required to be solved urgently by those skilled in the art to provide a distributed acoustic sensing system based on an optical neural network and an all-optical integration method to solve the difficulties in the prior art.

### SUMMARY

In view of this, the present invention provides a distributed acoustic sensing system based on an optical neural network and an all-optical integration method, so as to solve the problems in the prior art.

To achieve the above objective, the present invention adopts the following technical solutions.

A distributed acoustic sensing system based on an optical neural network includes: a DAS optical path integrated part, an external connection part, and an integrated signal processing chip; wherein
the DAS optical path integrated part includes: a narrow-linewidth laser, an intensity modulator, a first optical amplifier;
the external connection part includes: a circulator and a sensing fiber; and
the integrated signal processing chip includes: a second optical amplifier, a first coupler, an optical delay line, a second coupler, a third coupler, a first polarizing beam splitter, a second polarizing beam splitter, a fourth coupler, a fifth coupler, a sixth coupler, an information conversion module, a spatio-temporal signal combination module, a pure optical neural network module, and a photoelectric conversion and control module.

According to the foregoing system, optionally, the narrow-linewidth laser, the intensity modulator and the first optical amplifier in the DAS optical path integrated part are connected in sequence; the intensity modulator is connected to a first output end of the photoelectric conversion and control module in the integrated signal processing chip;
an output end of the first optical amplifier is connected to a first port of the circulator in the external connection part;
the narrow-linewidth laser is configured to output continuous narrow-linewidth high coherence laser to the intensity modulator;
the intensity modulator is modulated by the photoelectric conversion and control module, modulates continuous probe light input by the narrow-linewidth laser into pulsed probe light, and outputs the pulsed probe light to the first optical amplifier; and
the first optical amplifier is configured to amplify a power of the pulsed probe light modulated by the intensity modulator and output the power to the first port of the circulator.

According to the foregoing system, optionally, in the external connection part, a second port of the circulator is connected to the sensing fiber, and a third port of the circulator is connected to an input end of the second optical amplifier in the integrated signal processing chip;
the circulator is configured to output the pulsed probe light received by the first port of the circulator to the sensing fiber from the second port of the circulator, and output a Rayleigh backscattering light signal received by the second port of the circulator to the second optical amplifier in the integrated signal processing chip from the third port of the circulator; and
the sensing fiber is configured to receive the pulsed probe light input by the second port of the circulator and generate a Rayleigh backscattering light signal.

According to the foregoing system, optionally, the first coupler, the optical delay line, the second coupler, the third coupler, the first polarizing beam splitter, the second polarizing beam splitter, the fourth coupler, the fifth coupler and the sixth coupler in the integrated signal processing chip form a temperature control and vibration isolation module.

According to the foregoing system, optionally, the second optical amplifier is configured to amplify the Rayleigh backscattering light signal input by the third port of the circulator, and output amplified Rayleigh backscattering light signal to the first coupler in the temperature control and vibration isolation module.

According to the foregoing system, optionally, the first coupler is configured to split an optical signal input by the second optical amplifier into two paths, wherein one path of the optical signal is output to the second coupler by a first output port of the first coupler, and another path of the optical signal is output to the optical delay line by a second output port of the first coupler;
the optical delay line is configured to transmit the optical signal input by the second output port of the first coupler to the third coupler and eliminate multipath interference to achieve phase matching and time sequence synchronization;
the second coupler is configured to divide the optical signal input by the first output port of the first coupler into three paths, one path of the optical signal is output to the first polarizing beam splitter by a first output port of the second coupler, another path of the optical signal is output to the fifth coupler by a second output port of the second coupler, and the other path of the optical signal is output to the second polarizing beam splitter by a third output port of the second coupler;
the third coupler is configured to divide the optical signal input by the optical delay line into three paths, one path of the optical signal is output to the fourth coupler by a first output port of the third coupler, another path of the optical signal is output to the fifth coupler by a second output port of the third coupler, and the other path is output to the sixth coupler by a third output port of the third coupler;
the first polarizing beam splitter is configured to transmit the optical signal input by the first output port of the second coupler to the fourth coupler and generate 2π/3 phase shift;
the second polarizing beam splitter is configured to transmit the optical signal input by the third output port of the second coupler to the sixth coupler and generate 4π/3 phase shift;
the fourth coupler is configured to couple the optical signal input by the first polarizing beam splitter and the optical signal input by the first output port of the third coupler, and output the optical signals to a first input port of the information conversion module;
the fifth coupler is configured to couple the optical signal input by the second output port of the second coupler and the optical signal input by the second output port of the third coupler, and output the optical signals to a second input port of the information conversion module; and
the sixth coupler is configured to couple the optical signal input by the second polarizing beam splitter and the optical signal input by the third output port of the third coupler, and output the optical signals to a third input port of the information conversion module.

According to the foregoing system, optionally, the information conversion module is configured to convert optical intensity signals input by the fourth coupler, the fifth coupler and the sixth coupler into phase signals, and output the phase signals to the spatio-temporal signal combination module;
the spatio-temporal signal combination module is controlled by the photoelectric conversion and control module, and is configured to integrate a plurality of groups of spatio-temporal two-dimensional phase signals input by the information conversion module to form an integral spatio-temporal two-dimensional phase signal and then transmit the integral spatio-temporal two-dimensional phase signal to the pure optical neural network module;
the pure optical neural network module is configured to identify and classify the integral spatio-temporal two-dimensional phase signal input by the spatio-temporal signal combination module, and output the integral spatio-temporal two-dimensional phase signal to the photoelectric conversion and control module; and
the photoelectric conversion and control module receives an external trigger signal, and is configured to set probe light pulse parameters, control working states of the spatio-temporal signal combination module and the first intensity modulator, and convert time information, position information and event information input by the pure optical neural network module into electric signals to be output.

According to the foregoing system, optionally, the pure optical neural network is implemented by adopting a look-up table, wherein an optical memory consists of a non-volatile waveguide phase shifter; a signal of the pure optical neural network module is a simulated optical signal and is a spatio-temporal two-dimensional graph, and phase information is represented by using an intensity.

According to the foregoing system, optionally, the first optical amplifier and the second optical amplifier are semiconductor optical amplifiers.

An all-optical integration method of a distributed acoustic sensing system based on an optical neural network is applied to the distributed acoustic sensing systems based on an optical neural network according to any one of the aspects, and includes the following steps:
S1. a narrow-linewidth laser transmits continuous narrow-linewidth high-coherence laser to an intensity modulator, the intensity modulator is modulated by a photoelectric conversion and control module, modulates continuous probe light input by the narrow-linewidth laser into pulsed probe light and outputs the pulsed probe light to a first optical amplifier, and the first optical amplifier amplifies a power of the pulsed probe light modulated by the intensity modulator and outputs the power to a first port of a circulator;
S2. the circulator outputs the pulsed probe light input into the first port from a second port to a sensing fiber, and outputs a Rayleigh backscattering light signal received by the second port from a third port to a second optical amplifier;
S3. the second optical amplifier amplifies the Rayleigh backscattering light signal input by a third port of the circulator and outputs amplified signal to a first coupler, the first coupler splits an optical signal input by the optical amplifier into two paths, one path of the optical signal is output to a second coupler by a first output port of the first coupler, another path of the optical signal is output to an optical delay line by a second output port of the first coupler, and the optical delay line transmits the optical signal input by the second output port of the first coupler to a third coupler and eliminates multipath interference to achieve phase matching and time sequence synchronization;
S4. the second coupler splits the optical signal input by the first output port of the first coupler into three paths, one path of the optical signal is output to a first polarizing beam splitter by a first output port of the second coupler, another path of the optical signal is output to a fifth coupler by a second output port of the second coupler, and the other path of the optical signal is output to a second polarizing beam splitter by a third output port of the second coupler; the first polarizing beam splitter transmits the optical signal input by the first output port of the second coupler to a fourth coupler and generates 2π/3 phase shift; the second polarizing beam splitter transmits the optical signal input by the third output port of the second coupler to a sixth coupler and generates 4π/3 phase shift; the third coupler splits the optical signal input by the optical delay line into three paths, one path of the optical signal is output to a fourth coupler by a first output port of the third coupler, another path of the optical signal is output to a fifth coupler by a second output port of the third coupler, and the other path of the optical signal is output to a sixth coupler by a third output port of the third coupler;
S5. the fourth coupler couples the optical signal input by the first polarizing beam splitter and the optical signal input by the first output port of the third coupler, and outputs the optical signals to an information conversion module; the fifth coupler couples the optical signal input by the second output port of the second coupler and the optical signal input by the second output port of the third coupler, and outputs the optical signals to an information conversion module; the sixth coupler couples the optical signal input by the second polarizing beam splitter and the optical signal input by the third output port of the third coupler, and outputs the optical signals to an information conversion module;
S6. the information conversion module converts optical intensity signals input by the fourth coupler, the fifth coupler and the sixth coupler into phase signals, and outputs the phase signals to a spatio-temporal signal combination module;
S7. the spatio-temporal signal combination module is controlled by the photoelectric conversion and control module, integrates a plurality of groups of spatio-temporal two-dimensional phase signals input by the information conversion module to form an integral spatio-temporal two-dimensional phase signal and then transmits the integral spatio-temporal two-dimensional phase signal to a pure optical neural network module;
S8. the pure optical neural network module identifies and classifies the integral spatio-temporal two-dimensional phase signal input by the spatio-temporal signal combination module, and then outputs the integral spatio-temporal two-dimensional phase signal to the photoelectric conversion and control module; and
S9. the photoelectric conversion and control module receives an external trigger signal, and is configured to set probe light pulse parameters, control working states of the spatio-temporal signal combination module and a first intensity modulator, and convert time information, position information and event information input by the pure optical neural network module into electric signals to be output.

It may be known from the technical solutions that, compared with the prior art, the present invention provides a distributed acoustic sensing system based on an optical neural network and an all-optical integration method, which has the following beneficial effects:
1) an all-optical path design is adopted, a series of losses caused by photoelectric conversion are eliminated, the system stability is improved, and the system architecture is simplified;
2) a pure optical neural network (ONN) is configured for signal identification and classification, so that the parallel processing capability is enhanced, the data processing speed is increased, and the data processing capacity is increased;
3) the all-optical integration is adopted, so that the volume and the weight of the entire system are reduced, the power consumption of the system is reduced, and the durability and the reliability of the system are enhanced.

### BRIEF DESCRIPTION OF THE DRAWINGS

To more clearly illustrate the technical solutions in the embodiments of the present invention or in the prior art, the drawings required to be used in the description of the embodiments or the prior art are briefly introduced below. It is obvious that the drawings in the description below are merely embodiments of the present invention, and those of ordinary skill in the art can obtain other drawings according to the drawings provided without creative efforts.

FIG. 1 is a block diagram of a distributed acoustic sensing system based on an optical neural network according to the present invention;

FIG. 2 is a flow chart of a first method that may be implemented by an information conversion module, a spatio-temporal signal combination module, and a pure optical neural network module according to the present invention;

FIG. 3 is a structural diagram of a three-input look-up table in a second method that may be implemented by an information conversion module, a spatio-temporal signal combination module, and a pure optical neural network module according to the present invention;

FIG. 4 is a cross-sectional structural diagram of a non-volatile waveguide phase shifter of an optical memory integrated with a FEBTO crystal in an ONN according to the present invention; and

FIG. 5 is a flow chart of an all-optical integration method of a distributed acoustic sensing system based on an optical neural network according to the present invention.

### DETAILED DESCRIPTION OF THE EMBODIMENTS

The following clearly and completely describes the technical solutions in the embodiments of the present invention with reference to drawings in the embodiments of the present invention. It is clear that the described embodiments are merely a part rather than all of the embodiments of the present invention. Based on the examples of the present invention, all other examples obtained by those of ordinary skill in the art without creative efforts shall fall within the protection scope of the present invention.

In the present application, relational terms such as “first” and “second” are merely used to distinguish one entity or operation from another entity or operation without necessarily requiring or implying any actual relationship or order between such entities or operations; and a term “include”, “contain”, or any other variant thereof is intended to cover a non-exclusive inclusion, so that a process, a method, an article, or a device that includes a series of elements not only includes those elements but also includes other elements that are not expressly listed, or further includes elements inherent to such a process, method, article, or device. An element preceded by “includes a . . . ” does not, without more constraints, preclude the existence of additional identical elements in the process, method, article, or device that includes the element.

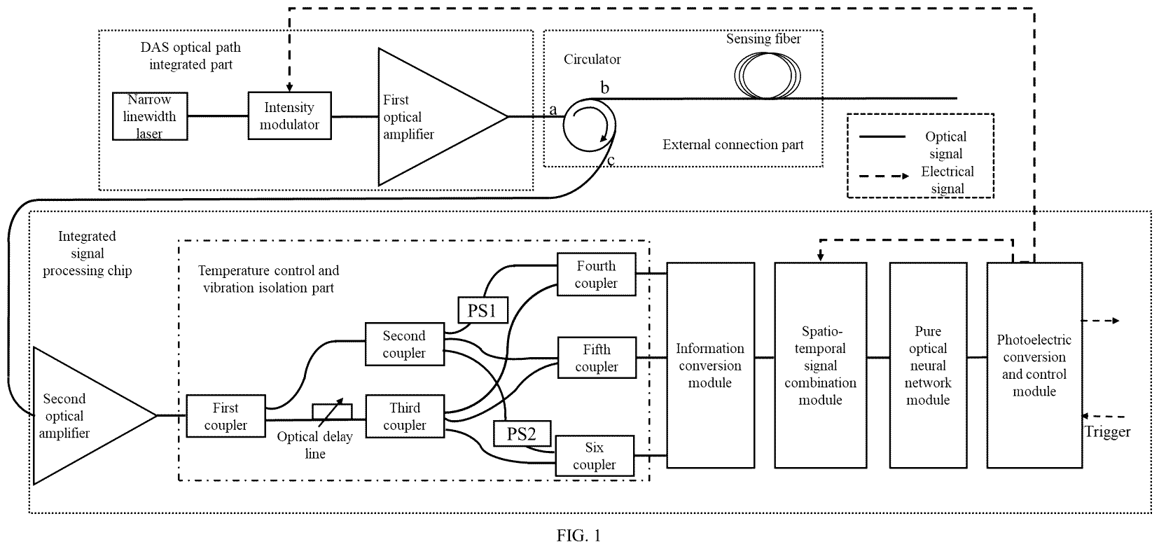

Referring to FIG. 1, the present invention discloses a distributed acoustic sensing system based on an optical neural network, which includes: a DAS optical path integrated part, an external connection part, and an integrated signal processing chip; wherein
the DAS optical path integrated part includes: a narrow-linewidth laser, an intensity modulator, a first optical amplifier;
the external connection part includes: a circulator and a sensing fiber; a first port of the circulator is represented by a in FIG. 1, a second port of the circulator is represented by b in FIG. 1, and a third port of the circulator is denoted by c in FIG. 1;
the integrated signal processing chip includes: a second optical amplifier, a first coupler, an optical delay line, a second coupler, a third coupler, a first polarizing beam splitter, a second polarizing beam splitter, a fourth coupler, a fifth coupler, a sixth coupler, an information conversion module, a spatio-temporal signal combination module, a pure optical neural network ONN module, and a photoelectric conversion and control module; and
the first polarizing beam splitter is represented by PS1 in FIG. 1 and the second polarizing beam splitter is represented by PS2 in FIG. 1.

Further, the narrow-linewidth laser, the intensity modulator and the first optical amplifier in the DAS optical path integrated part are connected in sequence; the intensity modulator is connected to a first output end of the photoelectric conversion and control module in the integrated signal processing chip;
an output end of the first optical amplifier is connected to a first port of the circulator in the external connection part;
the narrow-linewidth laser is configured to output continuous narrow-linewidth high coherence laser to the intensity modulator;
the intensity modulator is modulated by the photoelectric conversion and control module, modulates continuous probe light input by the narrow-linewidth laser into pulsed probe light, and outputs the pulsed probe light to the first optical amplifier; and
the first optical amplifier is configured to amplify a power of the pulsed probe light modulated by the intensity modulator and output the power to the first port of the circulator.

Specifically, the narrow-linewidth laser has a wavelength of 1550 nm and a linewidth of 100 kHz. Due to the limited coherence length, the phase demodulation needs to be performed by using the autocorrelation structure of the present invention. This design fully takes into account the core components with limited performance in current optoelectronic integration.

Further, in the external connection part, a second port of the circulator is connected to the sensing fiber, and a third port of the circulator is connected to an input end of the second optical amplifier in the integrated signal processing chip;
the circulator is configured to output the pulsed probe light received by the first port of the circulator to the sensing fiber from the second port of the circulator, and output a Rayleigh backscattering light signal received by the second port of the circulator to the second optical amplifier in the integrated signal processing chip from the third port of the circulator; and
the sensing fiber is configured to receive the pulsed probe light input by the second port of the circulator and generate a Rayleigh backscattering light signal.

Further, the first coupler, the optical delay line, the second coupler, the third coupler, the first polarizing beam splitter, the second polarizing beam splitter, the fourth coupler, the fifth coupler and the sixth coupler in the integrated signal processing chip form a temperature control and vibration isolation module. The temperature control and vibration isolation module greatly reduces the influence of external temperature and vibration on the system stability.

Further, the second optical amplifier is configured to amplify the Rayleigh backscattering light signal input by the third port of the circulator, and output amplified Rayleigh backscattering light signal to the first coupler in the temperature control and vibration isolation module.

Further, the first coupler is configured to split an optical signal input by the second optical amplifier into two paths, wherein one path of the optical signal is output to the second coupler by a first output port of the first coupler, and another path of the optical signal is output to the optical delay line by a second output port of the first coupler;
the optical delay line is configured to transmit the optical signal input by the second output port of the first coupler to the third coupler and eliminate multipath interference to achieve phase matching and time sequence synchronization;
the second coupler is configured to divide the optical signal input by the first output port of the first coupler into three paths, one path of the optical signal is output to the first polarizing beam splitter by a first output port of the second coupler, another path of the optical signal is output to the fifth coupler by a second output port of the second coupler, and the other path of the optical signal is output to the second polarizing beam splitter by a third output port of the second coupler;
the third coupler is configured to divide the optical signal input by the optical delay line into three paths, one path of the optical signal is output to the fourth coupler by a first output port of the third coupler, another path of the optical signal is output to the fifth coupler by a second output port of the third coupler, and the other path is output to the sixth coupler by a third output port of the third coupler;
the first polarizing beam splitter is configured to transmit the optical signal input by the first output port of the second coupler to the fourth coupler and generate stable 2π/3 phase shift;
the second polarizing beam splitter is configured to transmit the optical signal input by the third output port of the second coupler to the sixth coupler and generate stable 4π/3 phase shift;
the fourth coupler is configured to couple the optical signal input by the first polarizing beam splitter and the optical signal input by the first output port of the third coupler, and output the optical signals to a first input port of the information conversion module;
the fifth coupler is configured to couple the optical signal input by the second output port of the second coupler and the optical signal input by the second output port of the third coupler, and output the optical signals to a second input port of the information conversion module; and
the sixth coupler is configured to couple the optical signal input by the second polarizing beam splitter and the optical signal input by the third output port of the third coupler, and output the optical signals to a third input port of the information conversion module.

Specifically, the length of the optical delay line is selected in consideration of spatial resolution, system bandwidth, delay line loss, system stability, and other factors. Based on the foregoing all-optical integration method of the distributed acoustic sensing system based on the optical neural network, if the spatial resolution of the system is 10 m, the pulse width of the intensity modulator should be 50 ns, and if the required maximum delay time is 100 ns, the length of the optical delay line should be 20 m. The current practice of optical delay lines includes optical waveguide delay lines, optical fiber external connections and integrated delay lines. The designed average size of the optical waveguide delay lines is basically more than 50 cm². The size of the optical fiber external connections is generally more than several hundred cm³. The integrated optical delay lines have only a few cm² and are small in size, but the loss is extremely large; consequently, the integrated optical delay lines cannot be practically used.

The optical delay line in the system is designed by adopting an optimal solution. The delay is achieved by manufacturing a micro-ring resonator on a low-loss silicon nitride waveguide. When a wavelength of an optical signal meets a resonance condition of a ring optical waveguide, the optical signal circulates in the ring optical waveguide, thereby achieving the delay effect. To reduce loss, a plurality of micro-ring resonators connected in series are used. The total length of the delay line is 20 m, where the sources of loss include waveguide loss, coupling loss, bending loss, and amplification loss, totaling about 240 dB. Then, a pump light source is added, and the delay line is divided into 20 parts, so that SOA is added at the position where each part is connected. Each SOA may provide 12 dB of gain, thereby offsetting the loss and achieving a balance between gain and attenuation.

Based on the foregoing all-optical integration method of the distributed acoustic sensing system based on the optical neural network, if the spatial resolution of the system is 10 m, the pulse width of the intensity modulator should be 50 ns, and if the required maximum delay time is 100 ns, the length of the optical delay line should be 20 m. The optical delay line in the system is designed by adopting an optimal solution. Under the premise of silicon-based integration, a plurality of micro-ring resonators are cascaded, wherein each micro-ring resonator adopts an erbium-doped micro-ring resonator, and the design is optimized by adjusting the pump light power and the size of the ring, so that the optical path length of each micro-ring resonator is 1 cm, the gain is 2 dB, and the total attenuation of each micro-ring resonator is 2 dB. In addition, a plurality of pump light sources are distributed in the entire delay line, so that each micro-ring resonant cavity is ensured to obtain proper pump power, and finally 2000 micro-rings are required to be cascaded, so that the required delay distance and the actual gain-attenuation balance are achieved.

Further, the information conversion module is configured to convert optical intensity signals input by the fourth coupler, the fifth coupler and the sixth coupler into phase signals, and output the phase signals to the spatio-temporal signal combination module;
the spatio-temporal signal combination module is controlled by the photoelectric conversion and control module, and is configured to integrate a plurality of groups of spatio-temporal two-dimensional phase signals input by the information conversion module to form an integral spatio-temporal two-dimensional phase signal and then transmit the integral spatio-temporal two-dimensional phase signal to the pure optical neural network ONN module;
the pure optical neural network ONN module is configured to identify and classify the integral spatio-temporal two-dimensional phase signal input by the spatio-temporal signal combination module, and output the integral spatio-temporal two-dimensional phase signal to the photoelectric conversion and control module; and
the photoelectric conversion and control module receives an external trigger signal, and is configured to set probe light pulse parameters, control working states of the spatio-temporal signal combination module and the first intensity modulator, and convert time information, position information and event information input by the pure optical neural network ONN module into electric signals to be output.

Further, the pure optical neural network ONN is implemented by adopting a look-up table, wherein an optical memory consists of a non-volatile waveguide phase shifter; a signal of the pure optical neural network ONN module is a simulated optical signal and is a spatio-temporal two-dimensional graph, and phase information is represented by using an intensity. The pure optical neural network ONN is configured for signal identification and classification, so that the parallel processing capability is enhanced, the data processing speed is increased, and the data processing capacity is increased.

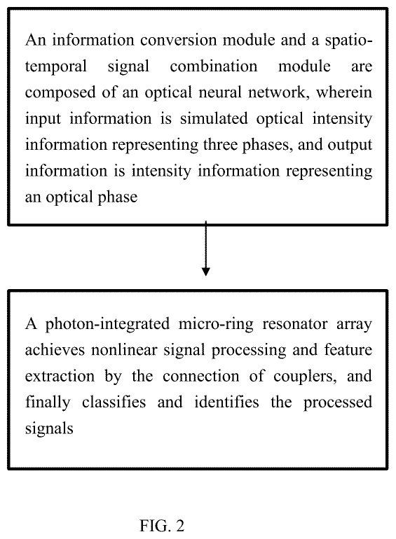

Referring to FIG. 2, a first method that may be implemented by an information conversion module, a spatio-temporal signal combination module, and a pure optical neural network module includes the following steps:
step I: the information conversion module and the spatio-temporal signal combination module are composed of an optical neural network, wherein the input information is three simulated optical intensity information representing phases output by a tri-port analogous structure, and the output information is a simulated optical intensity signal representing an optical phase; and
step II: the pure optical neural network module is composed of a plurality of micro-ring resonators, nonlinear processing and feature extraction of signals are achieved by connection of the couplers, and finally the processed signals are classified and identified.

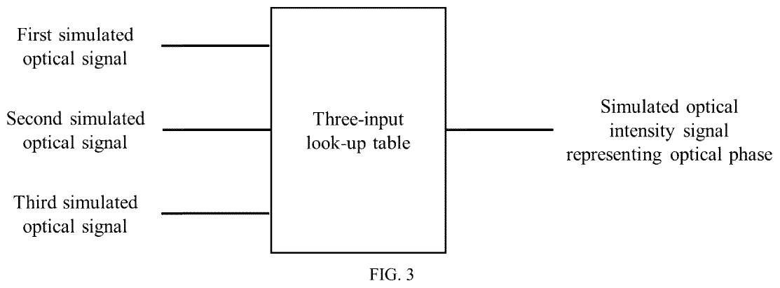

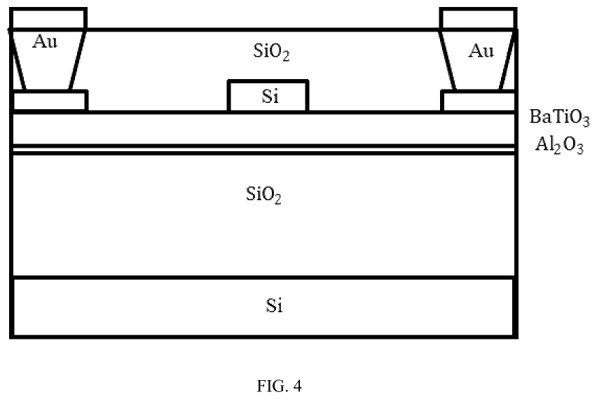

Referring to FIG. 3, a second method that may be implemented by an information conversion module, a spatio-temporal signal combination module, and a pure optical neural network module includes the following steps:
Step I: the information conversion module, the spatio-temporal signal combination module and the pure optical neural network module are achieved by adopting a look-up table (LUT), wherein the optical memory is an optical on-chip memory made of non-volatile materials. The look-up table is specifically a three-input look-up table, in which three simulated optical signals inputted therein represent phase information with intensity, and after passing through the lookup table, a simulated optical intensity signal representing the optical phase is outputted. The cross-sectional structure of the non-volatile waveguide phase shifter integrated with FEBTO crystal is shown in FIG. 4, and the phase shifter may be used as a basic building block of a photonic memory.
Step II: the obtained simulated optical intensity signal representing the optical phase enters the pure optical neural network module for final classification and identification.

Further, the first optical amplifier and the second optical amplifier are semiconductor optical amplifiers (SOAs).

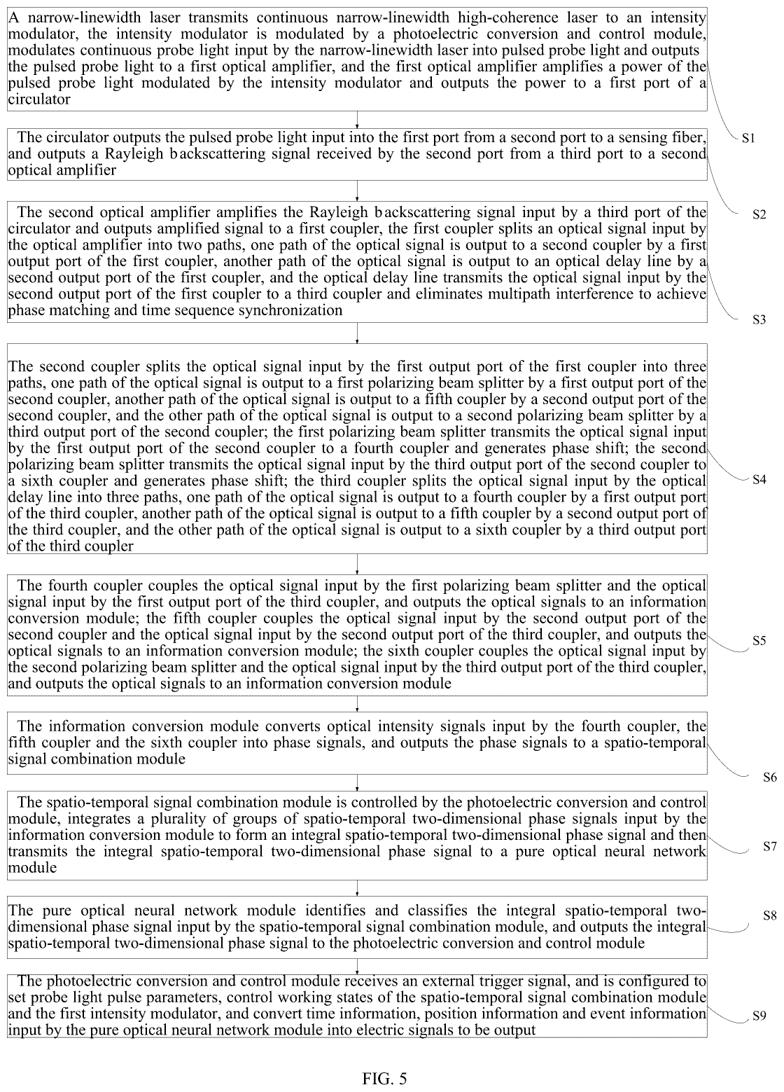

Corresponding to the system shown in FIG. 1, the present invention further discloses an all-optical integration method of a distributed acoustic sensing system based on an optical neural network, which is applied to the distributed acoustic sensing system based on the optical neural network according to any one of the aspects, and includes the specific steps shown in FIG. 5:
S1. a narrow-linewidth laser transmits continuous narrow-linewidth high-coherence laser to an intensity modulator, the intensity modulator is modulated by a photoelectric conversion and control module, modulates continuous probe light input by the narrow-linewidth laser into pulsed probe light and outputs the pulsed probe light to a first optical amplifier, and the first optical amplifier amplifies a power of the pulsed probe light modulated by the intensity modulator and outputs the power to a first port of a circulator;
S2. the circulator outputs the pulsed probe light input into the first port from a second port to a sensing fiber, and outputs a Rayleigh backscattering light signal received by the second port from a third port to a second optical amplifier;
S3. the second optical amplifier amplifies the Rayleigh backscattering light signal input by a third port of the circulator and outputs amplified signal to a first coupler, the first coupler is a 1*2 optical coupler (with a splitting ratio of 50:50) and splits an optical signal input by the optical amplifier into two paths, one path of the optical signal is output to a second coupler by a first output port of the first coupler, another path of the optical signal is output to an optical delay line by a second output port of the first coupler, and the optical delay line with a length of 20 m transmits the optical signal input by the second output port of the first coupler to a third coupler and eliminates multipath interference to achieve phase matching and time sequence synchronization;
S4. the second coupler is a 1*3 optical coupler (with a splitting ratio of 33:33:33) and splits the optical signal input by an output port 1 of the first coupler into three paths, one path of the optical signal is output to a first polarizing beam splitter by a first output port of the second coupler, another path of the optical signal is output to a fifth coupler by a second output port of the second coupler, and the other path of the optical signal is output to a second polarizing beam splitter by a third output port of the second coupler; the first polarizing beam splitter transmits the optical signal input by the first output port of the second coupler to a fourth coupler and generates 2π/3 phase shift; the second polarizing beam splitter transmits the optical signal input by the third output port of the second coupler to a sixth coupler and generates 4π/3 phase shift; the third coupler is a 1*3 optical coupler (with a splitting ratio of 33:33:33) and splits the optical signal input by the optical delay line into three paths, one path of the optical signal is output to a fourth coupler by a first output port of the third coupler, another path of the optical signal is output to a fifth coupler by a second output port of the third coupler, and the other path of the optical signal is output to a sixth coupler by a third output port of the third coupler;
S5. the fourth coupler couples the optical signal input by the first polarizing beam splitter and the optical signal input by the first output port of the third coupler, and outputs the optical signals to an information conversion module; the fifth coupler couples the optical signal input by the second output port of the second coupler and the optical signal input by the second output port of the third coupler, and outputs the optical signals to an information conversion module; the sixth coupler couples the optical signal input by the second polarizing beam splitter and the optical signal input by the third output port of the third coupler, and outputs the optical signals to an information conversion module;
S6. the information conversion module converts optical intensity signals input by the fourth coupler, the fifth coupler and the sixth coupler into phase signals, and outputs the phase signals to a spatio-temporal signal combination module;
S7. the spatio-temporal signal combination module is controlled by the photoelectric conversion and control module, integrates a plurality of groups of spatio-temporal two-dimensional phase signals input by the information conversion module to form an integral spatio-temporal two-dimensional phase signal and then transmits the integral spatio-temporal two-dimensional phase signal to a pure optical neural network ONN module;
S8. the pure optical neural network ONN module identifies and classifies the integral spatio-temporal two-dimensional phase signal input by the spatio-temporal signal combination module, and outputs the integral spatio-temporal two-dimensional phase signal to the photoelectric conversion and control module; and
S9. the photoelectric conversion and control module receives an external trigger signal, and is configured to set probe light pulse parameters, control working states of the spatio-temporal signal combination module and the first intensity modulator, and convert the three types of information of time, position, and event input by the pure optical neural network ONN module into electric signals to be output.

The various embodiments in the present specification are all described in a progressive manner. The various embodiments may refer to other embodiments for the same or similar parts, and each of the embodiments focuses on the parts differing from the other embodiments. Especially, a system and a system embodiment are basically similar to the method embodiment, and therefore are described briefly. For related parts, refer to descriptions in the method embodiments. The system and the system embodiment described above are merely an example. The units described as separate parts may or may not be physically separate, and parts displayed as units may or may not be physical units, may be located in one position, or may be distributed on a plurality of network units. Some or all the modules may be selected according to an actual need to achieve the objectives of the solutions of the embodiments. Those of ordinary skill in the art may understand and implement embodiments of the present invention without creative efforts.

The above description of the disclosed embodiments enables those skilled in the art to implement or use the present invention. Various modifications to these embodiments will be readily apparent to those skilled in the art, and the generic principles defined herein may be applied to other embodiments without departing from the spirit or scope of the present invention. Thus, the present invention is not intended to be limited to these embodiments shown herein but is to be accorded the broadest scope consistent with the principles and novel features disclosed herein.

What is claimed is:

1. A distributed acoustic sensing system based on an optical neural network, comprising: a distributed acoustic sensing (DAS) optical path integrated part, an external connection part, and an integrated signal processing chip; wherein
the DAS optical path integrated part comprises: a narrow-linewidth laser, an intensity modulator, and a first optical amplifier;
the external connection part comprises: a circulator and a sensing fiber; and
the integrated signal processing chip comprises: a second optical amplifier, a first coupler, an optical delay line, a second coupler, a third coupler, a first polarizing beam splitter, a second polarizing beam splitter, a fourth coupler, a fifth coupler, a sixth coupler, an information conversion module, a spatio-temporal signal combination module, a pure optical neural network module, and a photoelectric conversion and control module.

2. The distributed acoustic sensing system according to claim 1, wherein
the narrow-linewidth laser, the intensity modulator, and the first optical amplifier in the DAS optical path integrated part are connected in sequence; and the intensity modulator is connected to a first output end of the photoelectric conversion and control module in the integrated signal processing chip;
an output end of the first optical amplifier is connected to a first port of the circulator in the external connection part;
the narrow-linewidth laser is configured to output a continuous narrow-linewidth high coherence laser to the intensity modulator;
the intensity modulator is modulated by the photoelectric conversion and control module, modulates a continuous probe light input by the narrow-linewidth laser into a pulsed probe light, and outputs the pulsed probe light to the first optical amplifier; and
the first optical amplifier is configured to amplify a power of the pulsed probe light modulated by the intensity modulator and output the power to the first port of the circulator.

3. The distributed acoustic sensing system according to claim 2, wherein
in the external connection part, a second port of the circulator is connected to the sensing fiber, and a third port of the circulator is connected to an input end of the second optical amplifier in the integrated signal processing chip;
the circulator is configured to output the pulsed probe light received by the first port of the circulator to the sensing fiber from the second port of the circulator, and output a Rayleigh backscattering light signal received by the second port of the circulator to the second optical amplifier in the integrated signal processing chip from the third port of the circulator; and
the sensing fiber is configured to receive the pulsed probe light input by the second port of the circulator and generate the Rayleigh backscattering light signal.

4. The distributed acoustic sensing system according to claim 3, wherein
the first coupler, the optical delay line, the second coupler, the third coupler, the first polarizing beam splitter, the second polarizing beam splitter, the fourth coupler, the fifth coupler, and the sixth coupler in the integrated signal processing chip form a temperature control and vibration isolation module.

5. The distributed acoustic sensing system according to claim 4, wherein
the second optical amplifier is configured to amplify the Rayleigh backscattering light signal input by the third port of the circulator to obtain an amplified Rayleigh backscattering light signal, and output the amplified Rayleigh backscattering light signal to the first coupler in the temperature control and vibration isolation module.

6. The distributed acoustic sensing system according to claim 5, wherein
the first coupler is configured to split an optical signal input by the second optical amplifier into two paths, wherein a first path of the optical signal is output to the second coupler by a first output port of the first coupler, and a second path of the optical signal is output to the optical delay line by a second output port of the first coupler;
the optical delay line is configured to transmit the optical signal input by the second output port of the first coupler to the third coupler and eliminate a multipath interference to achieve a phase matching and a time sequence synchronization;
the second coupler is configured to divide the optical signal input by the first output port of the first coupler into three paths, a third path of the optical signal is output to the first polarizing beam splitter by a first output port of the second coupler, a fourth path of the optical signal is output to the fifth coupler by a second output port of the second coupler, and a fifth path of the optical signal is output to the second polarizing beam splitter by a third output port of the second coupler;
the third coupler is configured to divide the optical signal input by the optical delay line into three paths, a sixth path of the optical signal is output to the fourth coupler by a first output port of the third coupler, a seventh path of the optical signal is output to the fifth coupler by a second output port of the third coupler, and an eighth path of the optical signal is output to the sixth coupler by a third output port of the third coupler;
the first polarizing beam splitter is configured to transmit the optical signal input by the first output port of the second coupler to the fourth coupler and generate a 2π/3 phase shift;
the second polarizing beam splitter is configured to transmit the optical signal input by the third output port of the second coupler to the sixth coupler and generate a 4π/3 phase shift;
the fourth coupler is configured to couple the optical signal input by the first polarizing beam splitter and the optical signal input by the first output port of the third coupler to obtain first coupled optical signals, and output the first coupled optical signals to a first input port of the information conversion module;
the fifth coupler is configured to couple the optical signal input by the second output port of the second coupler and the optical signal input by the second output port of the third coupler to obtain second coupled optical signals, and output the second coupled optical signals to a second input port of the information conversion module; and
the sixth coupler is configured to couple the optical signal input by the second polarizing beam splitter and the optical signal input by the third output port of the third coupler to obtain third coupled optical signals, and output the third coupled optical signals to a third input port of the information conversion module.

7. The distributed acoustic sensing system according to claim 6, wherein
the information conversion module is configured to convert optical intensity signals input by the fourth coupler, the fifth coupler, and the sixth coupler into phase signals, and output the phase signals to the spatio-temporal signal combination module;
the spatio-temporal signal combination module is controlled by the photoelectric conversion and control module, and is configured to integrate a plurality of groups of spatio-temporal two-dimensional phase signals input by the information conversion module to form an integral spatio-temporal two-dimensional phase signal and then transmit the integral spatio-temporal two-dimensional phase signal to the pure optical neural network module;
the pure optical neural network module is configured to identify and classify the integral spatio-temporal two-dimensional phase signal input by the spatio-temporal signal combination module, and output the integral spatio-temporal two-dimensional phase signal to the photoelectric conversion and control module; and
the photoelectric conversion and control module receives an external trigger signal, and is configured to set probe light pulse parameters, control working states of the spatio-temporal signal combination module and a first intensity modulator, and convert time information, position information, and event information input by the pure optical neural network module into electric signals to be output.

8. The distributed acoustic sensing system according to claim 1, wherein
the pure optical neural network is implemented by adopting a look-up table, wherein an optical memory comprises a non-volatile waveguide phase shifter; and a signal of the pure optical neural network module is a simulated optical signal and is a spatio-temporal two-dimensional graph, and phase information is represented by using an intensity.

9. The distributed acoustic sensing system according to claim 1, wherein
the first optical amplifier and the second optical amplifier are semiconductor optical amplifiers.

10. An all-optical integration method applied to the distributed acoustic sensing system according to claim 1, and comprising the following steps:
S1, transmitting a continuous narrow-linewidth high-coherence laser to the intensity modulator by the narrow-linewidth laser, modulating the intensity modulator by the photoelectric conversion and control module, modulating a continuous probe light input by the narrow-linewidth laser into a pulsed probe light and outputting the pulsed probe light to the first optical amplifier, and amplifying a power of the pulsed probe light modulated by the intensity modulator and outputting the power to a first port of the circulator by the first optical amplifier;
S2, outputting the pulsed probe light input into the first port from a second port to the sensing fiber by the circulator, and outputting a Rayleigh backscattering light signal received by the second port from a third port to the second optical amplifier;
S3, amplifying the Rayleigh backscattering light signal input by the third port of the circulator to obtain an amplified Rayleigh backscattering light signal and outputting the amplified Rayleigh backscattering light signal to the first coupler by the second optical amplifier, splitting an optical signal input by the second optical amplifier into two paths by the first coupler, wherein a first path of the optical signal is output to the second coupler by a first output port of the first coupler, a second path of the optical signal is output to the optical delay line by a second output port of the first coupler, and transmitting the optical signal input by the second output port of the first coupler to the third coupler and eliminating a multipath interference to achieve a phase matching and a time sequence synchronization by the optical delay line;
S4, splitting the optical signal input by the first output port of the first coupler into three paths by the second coupler, wherein a third path of the optical signal is output to the first polarizing beam splitter by a first output port of the second coupler, a fourth path of the optical signal is output to the fifth coupler by a second output port of the second coupler, and a fifth path of the optical signal is output to the second polarizing beam splitter by a third output port of the second coupler; transmitting the optical signal input by the first output port of the second coupler to the fourth coupler and generating a 2π/3 phase shift by the first polarizing beam splitter; transmitting the optical signal input by the third output port of the second coupler to the sixth coupler and generating a 4π/3 phase shift by the second polarizing beam splitter; and splitting the optical signal input by the optical delay line into three paths by the third coupler, wherein a sixth path of the optical signal is output to the fourth coupler by a first output port of the third coupler, a seventh path of the optical signal is output to the fifth coupler by a second output port of the third coupler, and an eighth path of the optical signal is output to the sixth coupler by a third output port of the third coupler;
S5, coupling the optical signal input by the first polarizing beam splitter and the optical signal input by the first output port of the third coupler by the fourth coupler to obtain first coupled optical signals, and outputting the first coupled optical signals to the information conversion module; coupling the optical signal input by the second output port of the second coupler and the optical signal input by the second output port of the third coupler by the fifth coupler to obtain second coupled optical signals, and outputting the second coupled optical signals to the information conversion module; coupling the optical signal input by the second polarizing beam splitter and the optical signal input by the third output port of the third coupler by the sixth coupler to obtain third coupled optical signals, and outputting the third coupled optical signals to the information conversion module;
S6, converting optical intensity signals input by the fourth coupler, the fifth coupler, and the sixth coupler into phase signals, and outputting the phase signals to the spatio-temporal signal combination module by the information conversion module;
S7, controlling the spatio-temporal signal combination module by the photoelectric conversion and control module, integrating a plurality of groups of spatio-temporal two-dimensional phase signals input by the information conversion module to form an integral spatio-temporal two-dimensional phase signal and then transmitting the integral spatio-temporal two-dimensional phase signal to the pure optical neural network module;
S8, identifying and classifying the integral spatio-temporal two-dimensional phase signal input by the spatio-temporal signal combination module, and then outputting the integral spatio-temporal two-dimensional phase signal to the photoelectric conversion and control module by the pure optical neural network module; and
S9, receiving an external trigger signal by the photoelectric conversion and control module, wherein the photoelectric conversion and control module is configured to set probe light pulse parameters, control working states of the spatio-temporal signal combination module and a first intensity modulator, and convert time information, position information, and event information input by the pure optical neural network module into electric signals to be output.

11. The all-optical integration method according to claim 10, wherein in the distributed acoustic sensing system, the narrow-linewidth laser, the intensity modulator, and the first optical amplifier in the DAS optical path integrated part are connected in sequence; and the intensity modulator is connected to a first output end of the photoelectric conversion and control module in the integrated signal processing chip;
an output end of the first optical amplifier is connected to the first port of the circulator in the external connection part;
the narrow-linewidth laser is configured to output a continuous narrow-linewidth high coherence laser to the intensity modulator;
the intensity modulator is modulated by the photoelectric conversion and control module, modulates the continuous probe light input by the narrow-linewidth laser into the pulsed probe light, and outputs the pulsed probe light to the first optical amplifier; and
the first optical amplifier is configured to amplify the power of the pulsed probe light modulated by the intensity modulator and output the power to the first port of the circulator.

12. The all-optical integration method according to claim 11, wherein in the distributed acoustic sensing system, in the external connection part, the second port of the circulator is connected to the sensing fiber, and the third port of the circulator is connected to an input end of the second optical amplifier in the integrated signal processing chip;
the circulator is configured to output the pulsed probe light received by the first port of the circulator to the sensing fiber from the second port of the circulator, and output the Rayleigh backscattering light signal received by the second port of the circulator to the second optical amplifier in the integrated signal processing chip from the third port of the circulator; and
the sensing fiber is configured to receive the pulsed probe light input by the second port of the circulator and generate the Rayleigh backscattering light signal.

13. The all-optical integration method according to claim 12, wherein in the distributed acoustic sensing system, the first coupler, the optical delay line, the second coupler, the third coupler, the first polarizing beam splitter, the second polarizing beam splitter, the fourth coupler, the fifth coupler, and the sixth coupler in the integrated signal processing chip form a temperature control and vibration isolation module.

14. The all-optical integration method according to claim 13, wherein in the distributed acoustic sensing system, the second optical amplifier is configured to amplify the Rayleigh backscattering light signal input by the third port of the circulator to obtain an amplified Rayleigh backscattering light signal, and output the amplified Rayleigh backscattering light signal to the first coupler in the temperature control and vibration isolation module.

15. The all-optical integration method according to claim 14, wherein in the distributed acoustic sensing system, the first coupler is configured to split an optical signal input by the second optical amplifier into two paths, wherein the first path of the optical signal is output to the second coupler by the first output port of the first coupler, and the second path of the optical signal is output to the optical delay line by the second output port of the first coupler;
the optical delay line is configured to transmit the optical signal input by the second output port of the first coupler to the third coupler and eliminate the multipath interference to achieve the phase matching and the time sequence synchronization;
the second coupler is configured to divide the optical signal input by the first output port of the first coupler into three paths, the third path of the optical signal is output to the first polarizing beam splitter by the first output port of the second coupler, the fourth path of the optical signal is output to the fifth coupler by the second output port of the second coupler, and the fifth path of the optical signal is output to the second polarizing beam splitter by the third output port of the second coupler;
the third coupler is configured to divide the optical signal input by the optical delay line into three paths, the sixth path of the optical signal is output to the fourth coupler by the first output port of the third coupler, the seventh path of the optical signal is output to the fifth coupler by the second output port of the third coupler, and the eighth path of the optical signal is output to the sixth coupler by the third output port of the third coupler;
the first polarizing beam splitter is configured to transmit the optical signal input by the first output port of the second coupler to the fourth coupler and generate the 2π/3 phase shift;
the second polarizing beam splitter is configured to transmit the optical signal input by the third output port of the second coupler to the sixth coupler and generate the 4π/3 phase shift;
the fourth coupler is configured to couple the optical signal input by the first polarizing beam splitter and the optical signal input by the first output port of the third coupler to obtain the first coupled optical signals, and output the first coupled optical signals to a first input port of the information conversion module;
the fifth coupler is configured to couple the optical signal input by the second output port of the second coupler and the optical signal input by the second output port of the third coupler to obtain the second coupled optical signals, and output the second coupled optical signals to a second input port of the information conversion module; and
the sixth coupler is configured to couple the optical signal input by the second polarizing beam splitter and the optical signal input by the third output port of the third coupler to obtain the third coupled optical signals, and output the third coupled optical signals to a third input port of the information conversion module.

16. The all-optical integration method according to claim 15, wherein in the distributed acoustic sensing system, the information conversion module is configured to convert optical intensity signals input by the fourth coupler, the fifth coupler, and the sixth coupler into phase signals, and output the phase signals to the spatio-temporal signal combination module;
the spatio-temporal signal combination module is controlled by the photoelectric conversion and control module, and is configured to integrate the plurality of groups of spatio-temporal two-dimensional phase signals input by the information conversion module to form an integral spatio-temporal two-dimensional phase signal and then transmit the integral spatio-temporal two-dimensional phase signal to the pure optical neural network module;
the pure optical neural network module is configured to identify and classify the integral spatio-temporal two-dimensional phase signal input by the spatio-temporal signal combination module, and output the integral spatio-temporal two-dimensional phase signal to the photoelectric conversion and control module; and
the photoelectric conversion and control module receives an external trigger signal, and is configured to set probe light pulse parameters, control working states of the spatio-temporal signal combination module and the first intensity modulator, and convert time information, position information, and event information input by the pure optical neural network module into electric signals to be output.

17. The all-optical integration method according to claim 10, wherein in the distributed acoustic sensing system, the pure optical neural network is implemented by adopting a look-up table, wherein an optical memory comprises a non-volatile waveguide phase shifter; and a signal of the pure optical neural network module is a simulated optical signal and is a spatio-temporal two-dimensional graph, and phase information is represented by using an intensity.

18. The all-optical integration method according to claim 10, wherein in the distributed acoustic sensing system, the first optical amplifier and the second optical amplifier are semiconductor optical amplifiers.
